(19) United States
(12) Patent Application Publication
(10) Pub. No.: US 2006/0117588 A1
(43) Pub. Date: Jun. 8, 2006

(54) Template level

(76) Inventor: Jason Edward Moore, Kurrajong (AU)

Correspondence Address: MICHAEL MOLINS;MOLINS & CO., SUITE S, LEVEL 6, 139 MACQUARIE ST, SYDNEY NSW, 2000, AU

(21) Appl. No.: 11/289,583

(22) Filed: Nov. 30, 2005

(30) Foreign Application Priority Data
Dec. 8, 2004 (AU) 2004906998

(51) Int. Cl. G01D 21/00

(52) U.S. Cl. 33/645

(57) ABSTRACT

A template has an external perimeter, a pair of crossed levels, preferably spirit levels and an alignment opening. In preferred embodiments of the invention, the alignment opening lies between the pair of crossed levels. In some examples, the alignment opening has, at its lower extent, a sight glass. A central mound makes assembly and use of the device easier.

### BACKGROUND OF THE INVENTION

The invention pertains to templates and more particularly to a template incorporating spirit levels and an alignment opening with alignment markings.

### FIELD OF THE INVENTION

A wide variety of electrical components including household socket boxes, data and telephonic connection boxes etc are installed through or behind an opening in a hollow wall. In a typical installation, a metal or plastic box of one kind or another is located behind an opening in the wall and the opening is covered with a plate. The plate may have both ornamental and functional characteristics. Where more than one cover plate is to be installed on a single wall or on a two or more walls in the same room, or even in different rooms it is desirable that the plates be both equally spaced from a horizontal reference line such as the floor and level. In a conventional or manual installation, this alignment process is time consuming and requires a certain degree of skill.

### OBJECTS AND SUMMARY OF THE INVENTION

It is an object of the invention to provide a template for marking the location of an opening in a wall, the template incorporating levels as well as an alignment opening with alignment marks.

It is another object of the invention to provide a template that utilises a pair of crossed spirit levels between which is located an alignment opening with alignment marks.

It is a further object of the invention to provide a template having levels that is compact and convenient to manufacture.

It is yet another object of the invention to provide a template having levelling features as well as a sight glass.

Accordingly, there is provided a template having an external perimeter and a central mound. The mound incorporates a pair of crossed levels, preferably spirit levels and an alignment opening.

In preferred embodiments of the invention, the alignment opening lies between the pair of crossed levels.

In particularly preferred embodiments, the alignment opening has, at its lower extent, a sight glass.

### BRIEF DESCRIPTION OF THE DRAWING FIGURES

FIG. 1 is a perspective view of a template level made in accordance with the teachings of the present invention;

FIG. 2 is a top plan view of a device depicted in FIG. 3;

FIG. 3 is a perspective view of the base plate of the device depicted in FIGS. 1 and 2;

FIG. 4 is a perspective, inverted view of the central mound of the device depicted in FIGS. 1 and 2;

FIG. 5 is a cross section of the base plate; and

FIGS. 6(a), (b) & (c) are examples of alignment openings.

### BEST MODE AND OTHER EMBODIMENTS OF THE INVENTION

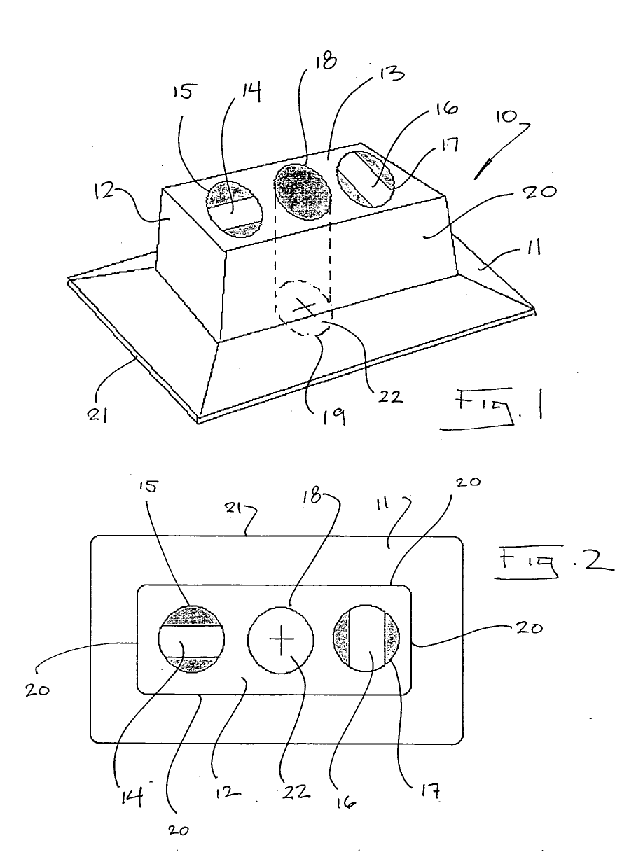

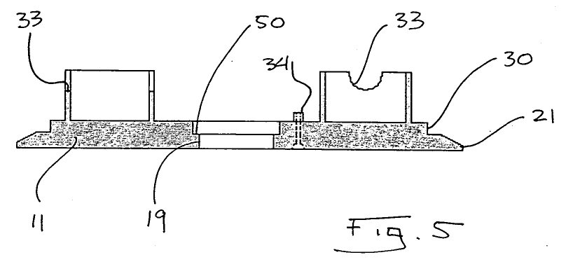

As shown in FIG. 1, a template level 10 comprises a base plate 11 that serves as a drawing template on the upper surface of which is located an optional, convenient gripping mound 12. The mound makes assembly and use of the device easier. In this example, the mound 12 is centrally located with respect to the edges of the base plate 11. Three separate openings or view windows are formed into the top surface 13 of the mound 12. A first level, such as a spirit level 14, is located within the mound 12 and is visible through a first opening 15. A second level 16 is oriented at 90° to the first level 14 and is also located within the mound 12. It is visible through a second opening 17 formed in the top surface 13 of the mound 12. A central or alignment opening 18 is located between the two levels. The alignment opening 18 is in registry with a cooperating opening 19 formed in the middle of the base plate 11. It is preferred that the exterior perimeter 20 of the mound be provided with a textured or ribbed surface that provides a convenient grip. FIG. 4 depicts vertical ribs 49 moulded around the outer perimeter of the mound 12.

In some embodiments, the peripheral edge 21 of the base plate 11 is thinner than the central portion. This makes drawing around the perimeter 21 easy and accurate without excessively compromising the rigidity of the base plate 11. As will be explained, the base plate 11 and mound 12 may be provided as separate components which are joined at the time of manufacture.

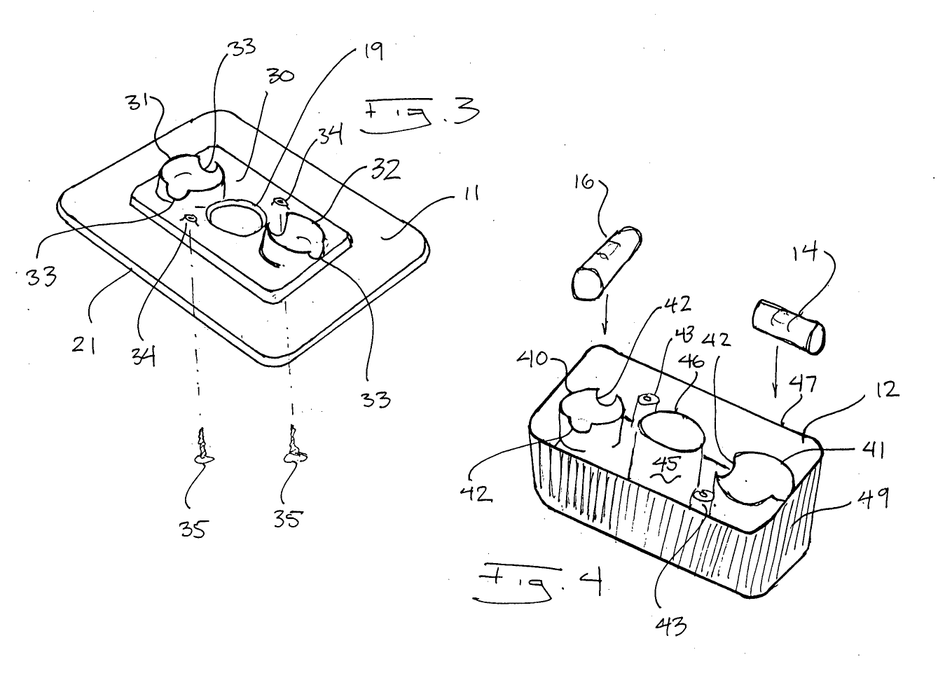

As shown in FIG. 2 the perimeter shape 21 of the base plate 11 may be provided to correspond with the size of an opening that accommodates a particular electrical or data fixture. It can also be seen that the central mound 12 provides, at a glance, a view to the user which includes both of the levels 14, 16 as well as the alignment opening 18. In this example, the alignment opening 18 has an open top but is terminated, by a sight glass 22 that is held in place, for example, by the lower rim of the descending side walls of the alignment opening 18, a recess in the base plate 11 or both of these.

As shown in FIG. 3, manufacture of the device is facilitated by moulding into the base plate 11, a central and raised pilot or island 30. The island acts like a pilot for the separate mound, during assembly. The island 30 incorporates a pair of cylindrical brackets 31, 32 that are used to retain the crossed levels 14, 16. Each bracket 31 includes a pair of diametrically opposed semi-circular recesses 33 that are used to retain the levels. The island 30 may also incorporate a central opening 19 that cooperates with the alignment opening 18 (in a variety of ways as will be explained). Through holes 34 may be provided so that fasteners 35 may be used to attach the base plate 11 to the mound 12.

As shown in FIG. 4, the mound 12 comprises a thin walled moulding. A second pair of cylindrical brackets 40, 41 cooperate with and form sidewalls to the openings 15, 17 on the top surface 13 of the mound. Each of the cylindrical brackets 40, 41 incorporates a pair of diametrically opposed semi-circular recesses 42 that cooperate with the recesses 33 on the base plate, to retain the levels 14, 16. One or more bosses may 43 may be moulded in to allow the self tapping fasteners 35 a convenient point of attachment. As best shown in FIG. 4, the alignment opening 18 is surrounded by a generally cylindrical side wall 45. The side wall 45 preferably extends at least to the opening 19 in the base plate 11 and is, in preferred embodiments, used to retain a sight glass which may be located within the base plate opening 19.

As shown in FIG. 5, the base plate 11 may have an opening 19 incorporating a circumferential shoulder 50 for retaining a sight glass (not shown). In this example, the sight glass will have imprinted on it cross hairs or alignment markings of one kind of another. In preferred embodiments, the lower edge 46 of the side wall 45 would make contact with the upper surface of the sight glass.

As suggested by FIGS. 3 and 4, the device may be assembled by inverting the mound into the orientation depicted in FIG. 4. In this orientation, the levels 14, 16 may be inserted into their respective recesses 42. With the levels in place, the base plate 11 can be placed over the mound so that the island 30 rests within and is piloted by the rim 47 of the mound 12. Assembly is completed by inserting the fasteners 35 through the base plate and into the bosses 43.

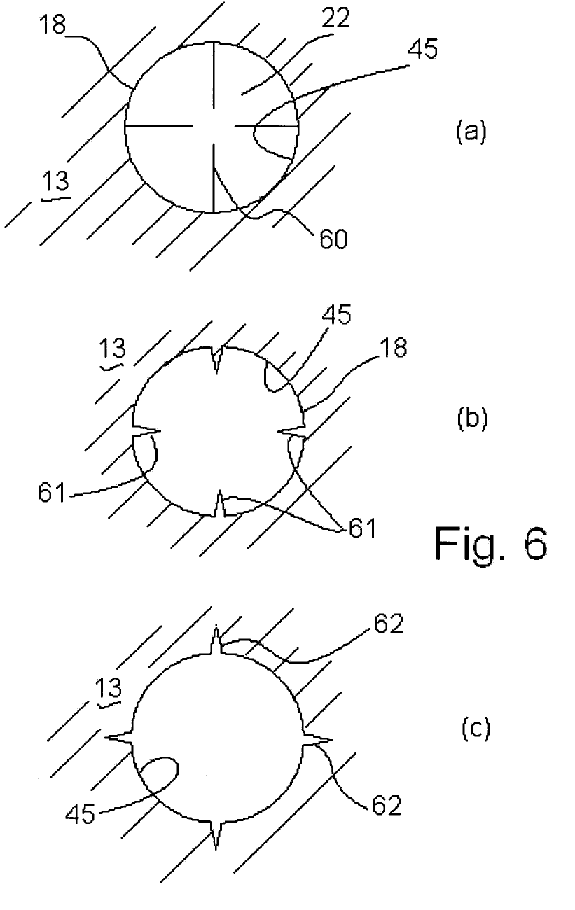

FIGS. 6(a), (b) and (c) illustrate three different styles of alignment opening. FIG. 6(a) suggests the type of view that would be seen through the alignment opening 18 where a sight glass 22 is used. Note that the sight glass may incorporate any variety of alignment markings 60. A second variation is depicted in FIG. 6 (b). In this embodiment, the alignment opening 18 is used with or without a sight glass. Instead of alignment markings 60, being physical features 61, are moulded either into the side wall 45 or into the base plate around the circumference of the central opening 19. These features provide visual indications which make identification of the centre of the alignment opening 18 easy to find. A related embodiment is depicted in FIG. 6(c). In this example, physical alignment features comprise the removal of material 62 either from the periphery of the base plate opening 19 or from the side wall 45 of the alignment opening 18. Similar to the examples provided in FIGS. 6(a) and (b) the physical features 62 provide a convenient visual reference that indicates where the centre of the alignment opening 18 is located.

In one example, the device is used by either drawing a line or providing reference points which are a constant height above a reference such as a skirting board or a floor. The template level 10 of the present invention is then located over these points or this line so that the points or the line are visible through and centred in the alignment opening 18. When the line or the points are centred with respect to the alignment opening 18, and one of the levels shows that the device is in a level orientation, a mark is made around the perimeter 21. This mark indicates where a hole is cut. Because the device incorporates crossed levels 14, 16 it is suitable for templating a rectangular opening whose long axis is either horizontal or vertical. It will be appreciated that if the perimeter 21 were square, only a single level would be required. Similarly, if the device were only to be used in one orientation, only one level would be required.

While the present invention has been described with reference to particular details of construction, these should be understood as having been provided by way of example and not as limitations to the scope of spirit or the invention.

What is claimed is:

1. A template level device, comprising:
a base upon which is located a gripping mound located within a perimeter;
the mound having three view windows;
two of the windows each having located within, a level, the levels oriented at 90 degrees to one another;
a third one of the windows being an alignment opening.

2. The device of claim 1, wherein:
the gripping mound has a perimeter comprising a textured surface that provides a convenient grip.

3. The device of claim 1, wherein:
the base further comprises a base plate in which is formed an opening that is in registry with the alignment opening.

4. The device of claim 3, wherein:
the base plate has a peripheral edge that is thinner than a central portion of the plate.

5. The device of claim 3, wherein:
a sight glass is located in registry with the alignment opening.

6. The device of claim 3, wherein:
the mound is a separate component and the base plate further comprises a raised pilot that cooperates with the mound during assembly.

7. The device of claim 3, wherein:
the base plate further supports a pair of first brackets into which are mounted the two levels.

8. The device of claim 7, wherein:
the mound further comprises a second pair of brackets that cooperate with the first brackets to retain the levels.

9. The device of claim 1, wherein:
the mound is located centrally on the base, the mound having three windows; the alignment opening being located between the two other windows.

10. The device of claim 3, wherein:
the alignment opening further comprises a through opening having a side wall that extends to the opening in the base plate.

11. A template level device, comprising:
a template in which is formed, three view windows;
two of the windows each having located within, a level, the levels oriented at 90 degrees to one another;
a third one of the windows being an alignment opening.

12. The device of claim 11, wherein:
the template has an upper surface and grip that extends above the upper surface.

13. The device of claim 11, wherein:
the alignment opening is a through opening located in the middle of the device.

14. The device of claim 11, wherein:
the template has a peripheral edge that is thinner than a central portion of the plate.

15. The device of claim 11, wherein:
a sight glass is located in registry with the alignment opening.

16. The device of claim 11, wherein:
a gripping mound is provided a separate component during assembly and the device further comprises a base plate with a raised pilot that cooperates with the mound during assembly.

17. The device of claim 16, wherein:
the base plate further supports a pair of first brackets into which are mounted the two levels.

18. The device of claim 17, wherein:
the mound further comprises a second pair of brackets that cooperate with the first brackets to retain the levels.

19. The device of claim 18, wherein:
the mound is located centrally on the base, the mound having three windows;
the alignment opening being located between the two other windows.

20. The device of claim 19, wherein:
the alignment opening further comprises a through opening having a side wall that extends to the opening in the base plate.
